(19) United States
(12) Patent Application Publication
(10) Pub. No.: US 2022/0167738 A1
(43) Pub. Date: Jun. 2, 2022

(54) MAKEUP BRUSH CLEANING DEVICE

(71) Applicants: Heya Kaakeh, West Lafayette, IN (US); Dina Wasfi Abdulaal, Boston, MA (US); Robbie Virginia Williams, Cincinnati, OH (US); Emily Catherine Eifert, Denver, CO (US); Mina Elise Mohsenian, Pewaukee, WI (US); Kevin Sanabria, Troy, MI (US)

(72) Inventors: Heya Kaakeh, West Lafayette, IN (US); Dina Wasfi Abdulaal, Boston, MA (US); Robbie Virginia Williams, Cincinnati, OH (US); Emily Catherine Eifert, Denver, CO (US); Mina Elise Mohsenian, Pewaukee, WI (US); Kevin Sanabria, Troy, MI (US)

(21) Appl. No.: 17/520,383

(22) Filed: Nov. 5, 2021

Related U.S. Application Data
(60) Provisional application No. 63/110,050, filed on Nov. 5, 2020.

(51) Int. Cl. A46B 17/06; B08B 11/02

(52) U.S. Cl. CPC A46B 17/06; A46B 2200/1046; B08B 11/02

(57) ABSTRACT

A makeup brush cleaning device is provided that includes a housing and a carriage.

### RELATED APPLICATIONS

The present application claims the benefit of U.S. patent application Ser. No. 63/110,050, filed Nov. 5, 2020, to Heya Kaakeh et al., and titled “Cosmetic Brush Cleaner,” the complete disclosure of which is expressly incorporated by reference herein.

### TECHNICAL FIELD

The present disclosure is directed to a cleaning and drying device. More specifically, this disclosure describes a cleaning and drying device for makeup brushes.

### BACKGROUND AND SUMMARY OF THE DISCLOSURE

The following statements are intended to facilitate an understanding of the present disclosure. The statements are to be read in this light should not be construed as admissions of prior art.

Makeup brushes are used to apply makeup to a user's face. It is known to wash makeup brushes to remove residual makeup from the bristles and to increase hygiene. Once makeup brushes have been washed, it is known to dry the brushes before the next use.

According to the present disclosure, a makeup cleaning device is provided. The device includes a housing and a carriage.

According to one aspect of the present disclosure, a makeup brush cleaning device assembly is provided. The assembly includes a makeup brush cleaning device and a plurality of makeup brushes. The makeup brush cleaning device includes a housing, a carriage positioned in the housing, a water supply, and a forced air source. The plurality of makeup brushes is supported by the carriage. The water supply is positioned to provide water to the plurality of makeup brushes during a wash cycle and a rinse cycle. The forced air source is positioned to provide air to the plurality of makeup brushes during a dry cycle.

According to another aspect of the present disclosure, a makeup brush cleaning device is provided. The device includes a housing and a carriage positioned in the housing. The carriage includes a plurality of brush supports and a gear assembly coupled to the plurality of brush supports. The brush supports are configured to support at least one makeup brush, and the gear assembly is configured to rotate the makeup brushes about longitudinal axes of the makeup brushes.

According to another aspect of the present disclosure, a makeup brush cleaning device assembly is provided. The assembly includes a makeup brush cleaning device and a plurality of makeup brushes. The makeup brush cleaning device includes a housing, a carriage supported by the housing, and a motor coupled to the carriage. The carriage supports the plurality of makeup brushes. The motor revolves the plurality of makeup brushes about an axis.

### BRIEF DESCRIPTION OF THE DRAWINGS

The previously described aspects of this disclosure will grow to be appreciated at a greater level once references to the following accompanying illustrations are expounded upon.

FIG. 1 is a front perspective view of a makeup brush cleaning device having a base, a hexagonal housing having a window, a hexagonal lid positioned on the hexagonal housing, a left water supply tank, and a right drain tank;

FIG. 2 is a side view of the makeup brush cleaning device (with the lid removed) of FIG. 1 showing a forced air supply positioned to supply forced air to the hexagonal housing;

FIG. 3 is a rear view of the makeup brush cleaning device (with the lid removed) of FIG. 1 showing the forced air supply, a water supply including the left water tank positioned to the right of the hexagonal housing to supply water to the hexagonal housing, and the right drain tank positioned to the left of the hexagonal housing and connected to the housing by a hose and valve;

FIG. 4A is a bottom perspective view of the lid (with sidewalls removed) of the makeup brush cleaning device of FIG. 1 showing the lid detached from the housing and having a carriage including a planetary gear system and a plurality of brush supports supported by the carriage;

FIG. 4B is an enlarged view of a portion of FIG. 4A showing enlarged details of one of the plurality of brush supports;

FIG. 4C is a top perspective view of a brush support of the lid of FIG. 4A showing the brush support having a plurality of jaws, a hinge, and a malleable inner member, the jaws being in an open position;

FIG. 5 is a top view of the planetary gear system of the lid of FIG. 4A;

FIG. 6 is a front view of the makeup cleaning device (with the lid sidewalls and a housing sidewall removed) of FIG. 1 showing one of a plurality of linear actuator supporting the carriage in a lowered position to support makeup brushes in a wash or rinse cycle with the bristles (not shown) of the makeup brushes contacting an abrasive surface (not shown);

FIG. 7 is a view similar to FIG. 6 showing the linear actuators supporting the carriage at a raised position to support makeup brushes during a dry cycle out of the fluid, with the bristles (not shown) of the makeup brushes spaced apart from the abrasive surface (not shown);

FIG. 8 is an exploded linear view of the hexagonal housing of the makeup brush cleaning device of FIG. 1, showing the housing having a base, sidewalls, linear actuators, an inner tank, an agitation pad, and a top supporting electrical connectors;

FIG. 9 is a bottom view of the makeup cleaning device of FIG. 1 (with portions of the base removed) showing pumps positioned to move water from the water tank to the hexagonal housing and removed water from the hexagonal housing to the drain tank;

FIG. 10 is a front view of the makeup cleaning device of FIG. 1 (with portions of the base and the housing removed) showing the pumps and water and drain tanks; and

FIG. 11 is a flow chart that shows the process the makeup brush cleaning device goes through to wash rinse and/or dry the plurality of makeup brushes.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. Unless otherwise indicated or apparent, the components shown in the figures are proportional to each other. It will be understood that no limitation of the scope of the disclosure is thereby intended. The disclosure includes any alterations and further modifications in the illustrative devices and described methods and further applications of the principles of the disclosure, which would no tally occur to one skilled in the art to which the disclosure relates.

For the purpose of understanding the present disclosure, specific language will be used to describe the embodiments illustrated in the drawings. No limitation in the scope of the present disclosure is intended by the detailed descriptions.

### DETAILED DESCRIPTION OF THE DRAWINGS

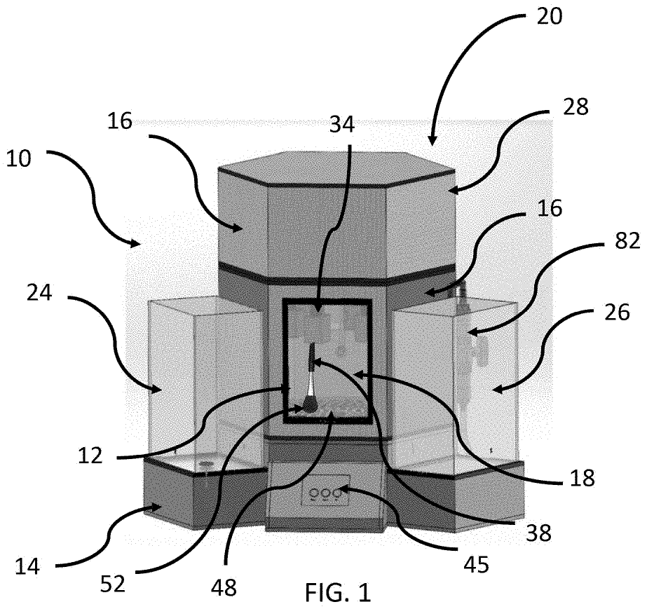

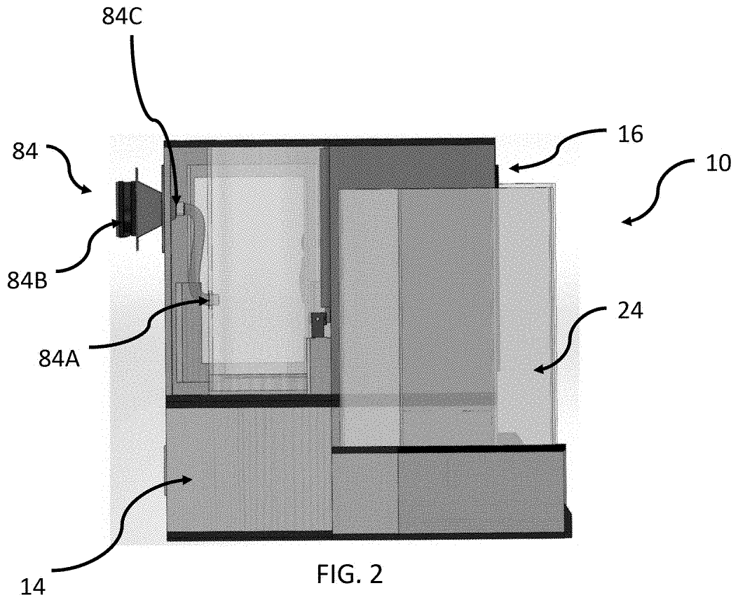

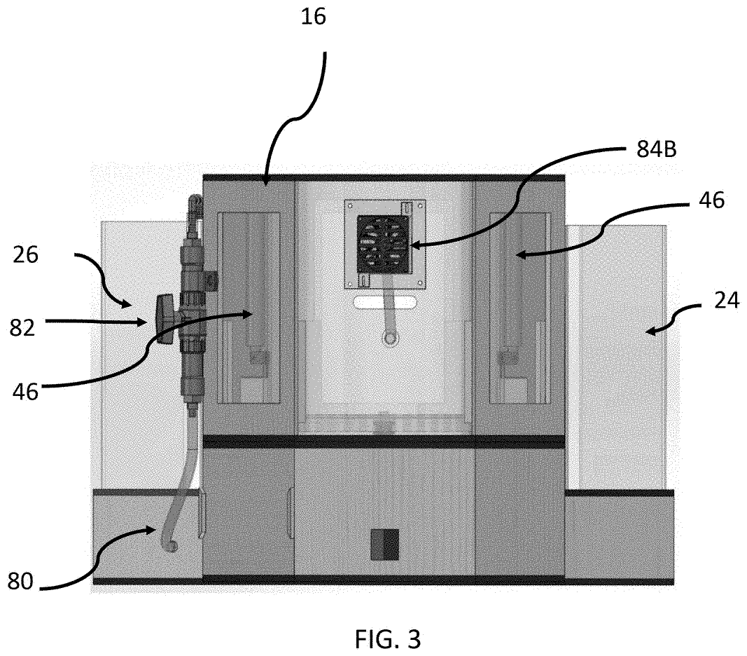

According to the present disclosure, a makeup brush cleaning device 10 is provided as shown in FIG. 1. Makeup brush cleaning device 10 preferably washes, rinses, and/or dries a plurality of makeup brushes 12, Makeup brush cleaning device 10 has a base 14, a hexagonal housing 16 having an outer shell 17, a window 18, an inner tank 19, and a base 21, a hexagonal lid 20 positioned on hexagonal housing 16, a left water supply tank 24, and a right drain tank 26.

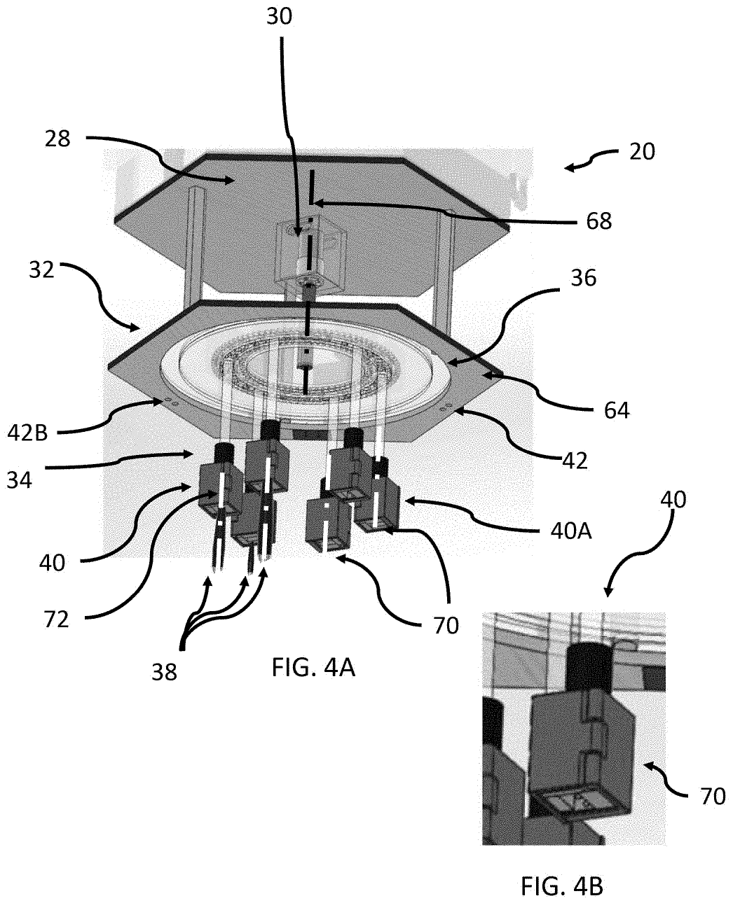

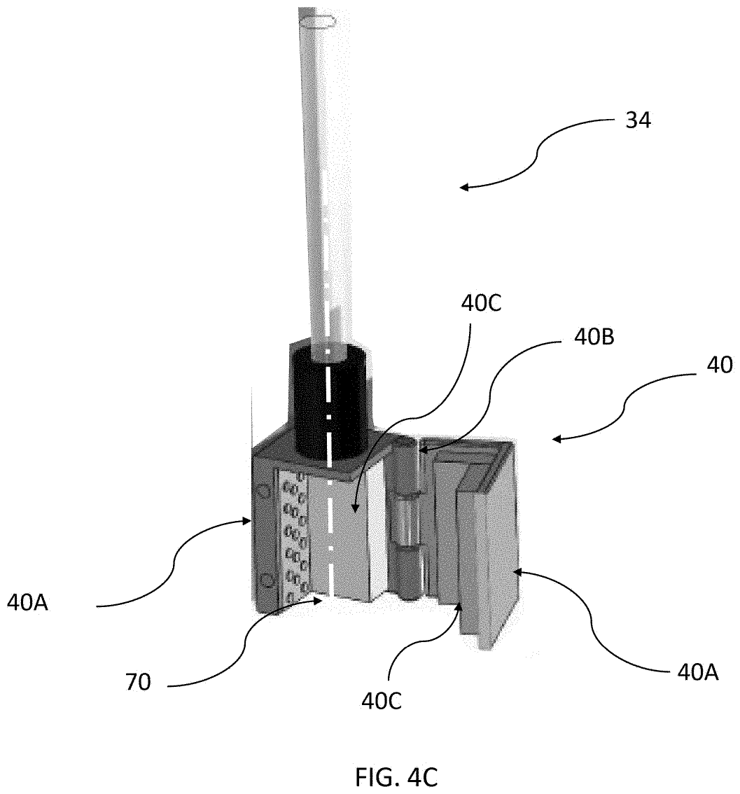

When a user operates makeup brush cleaning device 10, a user first removes lid 20 from housing 16. As shown in FIG. 4A, lid 20 preferably includes a housing 28, a motor 30 positioned in housing 28, and a carriage 32. Carriage 32 has a plurality of brush supports 34 configured to support makeup brushes 12 and a gear assembly 36 configured to move brush supports 34 and brushes 12 about during the wash, rinse, and/or dry cycle.

A user inserts a makeup brush handle 38 into clamps 40 of brush supports 34 by pivoting at least two outer jaws 40A of a respective clamp 40 from a closed position to an open position about a hinge 40B of clamp 40. When outer jaws 40A are in the open position, the user can insert handle 38 of a makeup brush 12 into a respective clamp 40, positioning handle 38 against a malleable inner member 40C. The user may then pivot outer jaws 40A from an open position to a closed position to secure handle 38 in place. When outer jaws 40A are in a closed position, malleable inner member 40C conforms to a size and shape of handle 38. To remove handle 38 from clamp 40, the user may then pivot outer jaws 40A from the closed position to the open position unlatching a latch or other component securing outer jaws 40A together.

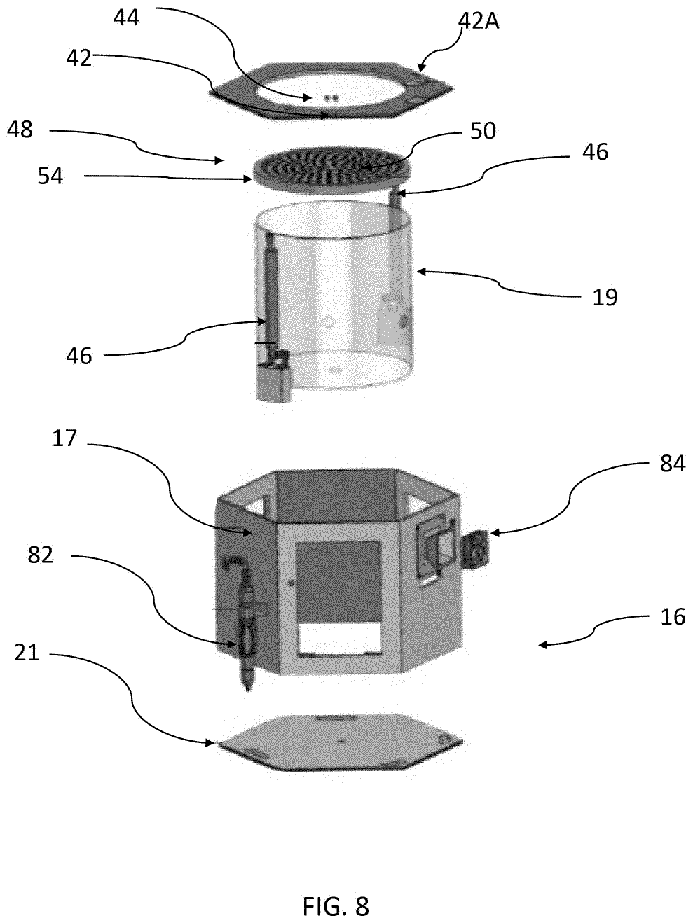

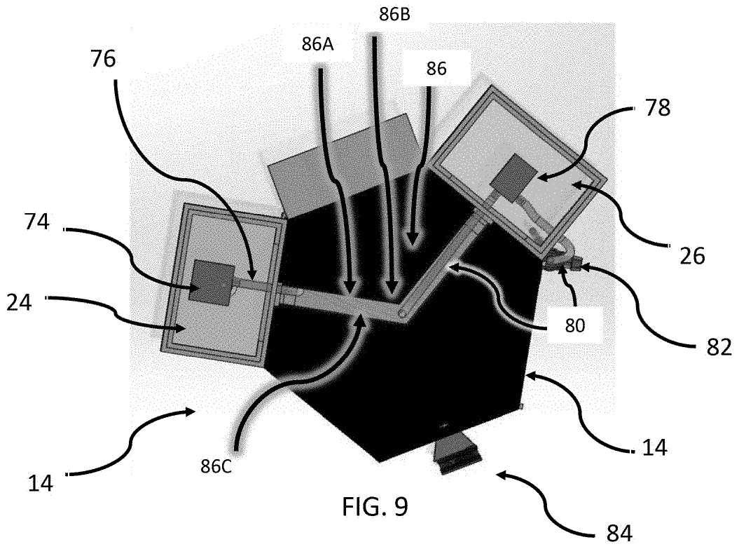

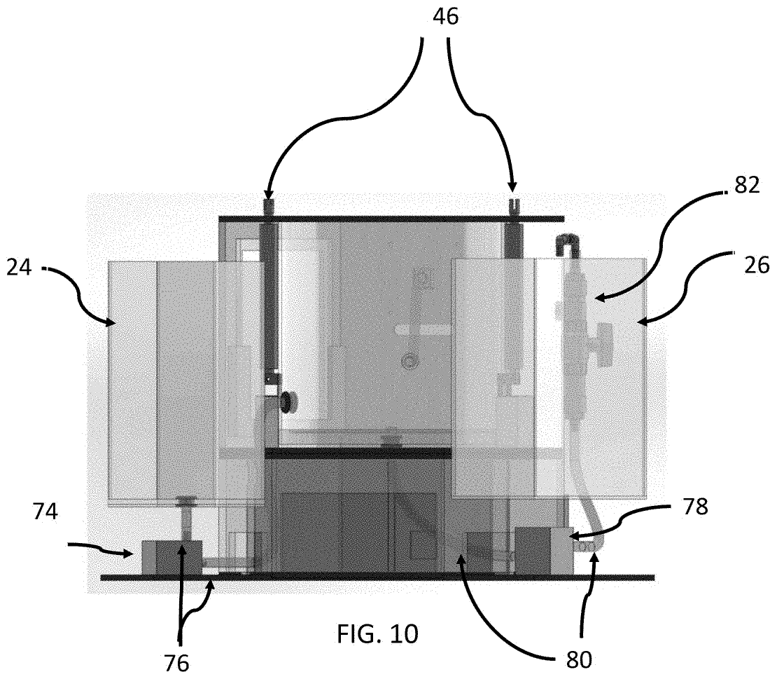

After securing plurality of makeup brushes 12 to carriage 32, the user may then position lid 20 back on housing 16. Once lid 20 contacts housing 16, an electrical connection 42 is re- established to motor 30. In the preferred embodiment, electrical connection 42 includes a spring- loaded electrical pin connection assembly 44, as shown in FIG. 8. According to the preferred embodiment, electrical connection 42 has a first connector 42A supported by housing 16 and a second connector 42B supported by lid 20, first and second connectors 42A, 42B are in contact to communicating electricity when lid 20 is supported by housing 16 and first and second connectors 42A, 42B are separated when lid 20 is removed from housing 16.

According to the preferred embodiment, housing 16, and lid 20 are hexagonal in shape. However, according to alternative embodiments, housing 16 and lid 20 may be cylindrical in shape, i.e., a circle cross section, an oval cross section, or a rounded cross section with at least one flat side, may be prismatic in shape, i.e., have a polygon cross section, may be polyhedral in shape, i.e., have polygon cross sections of varying sizes, or ellipsoid in shape, i.e., have circle cross sections of varying shape, oval cross sections of varying shape, or rounded cross section.

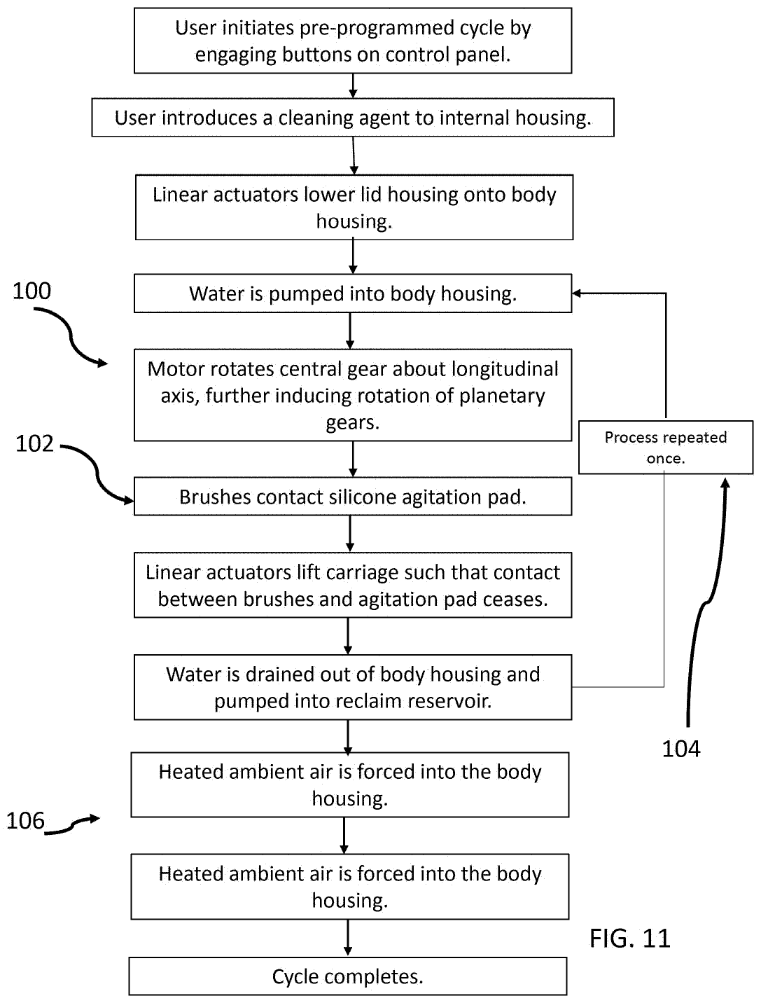

Prior to initiating a wash cycle 100 (see FIG. 11), a user, preferably, fills water supply tank 24 with water (not shown) and adds a cleaning agent, such as liquid or dry soap (not shown), to housing 16. The user can then initiate an automated agitation cycle 102. In the preferred embodiment, the user initiates the automated agitation cycle 102 by selecting a preferred cycle from a list of options provided on a control panel 45.

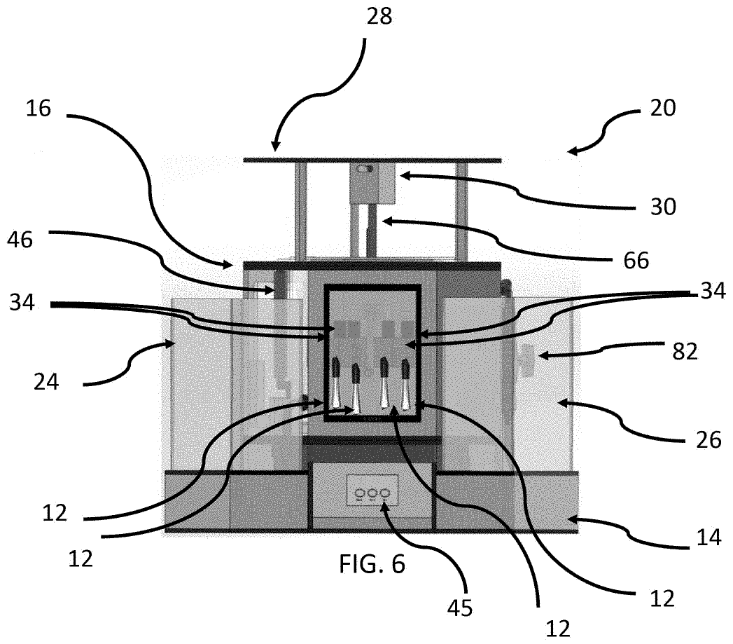

Before beginning wash cycle 100, linear actuators 46 lower carriage 32 to a lowered position inside housing 16, as shown in FIG. 6. Linear actuators 46 moves carriage 32 relative to housing 16 and lid housing 28. As shown in FIG. 1, a silicone, agitation pad 48 is positioned on base 21 of housing 16. As shown in FIG. 8, agitation pad 48 has a plurality of protrusions 50 on at least one side. When carriage 32 is in lowered position, bristles 52 of makeup brushes 12 contacts agitation pad 48. In the preferred embodiment, protrusions 50 are 1 cm in diameter and extend 1 cm from surface 54 of agitation pad 48. According to alternative embodiments, protrusions 50 may be less than 1 cm, i.e., 0.5 cm, or larger than 1 cm, i.e., 3 cm, in diameter. Additionally, according to alternative embodiments, protrusions may be extend less than 1 cm from surface 54, i.e., 0.5 cm, or extend more than 1 cm from surface 54, i.e., 1 cm.

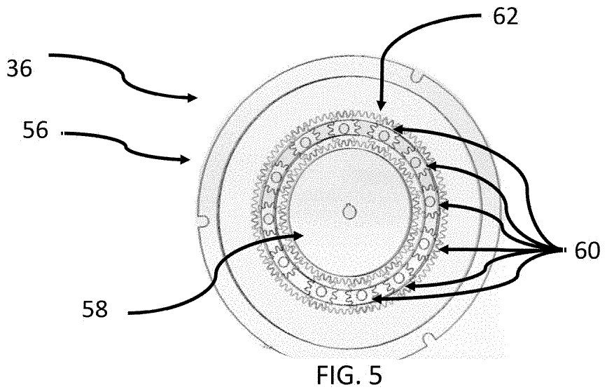

As shown in FIG. 5, gear assembly 36 is preferably a planetary gear system 56 comprising a sun gear 58, a plurality of planetary gears 60 positioned around sun gear 58, and an outer ring gear 62. Outer ring gear 62 may be integral with a base 64 of carriage 32 or a separate component coupled to base 64. According to the preferred embodiment, planetary gear assembly 36 comprises toothed spur gears, as shown in FIG. 5. However, according to alternative embodiments, planetary gear assembly 36 may comprise other toothed gears, such as bevel gears, or toothless gears, such as elastomeric or other rollers.

Motor 30 is positioned to drive a shaft 66 keyed to sun gear 58 to turn sun gear 58. Turning sun gear 58 causes planetary gears 60 to revolve around a central, longitudinal axis 68 of sun gear 58 and to rotate about a longitudinal axis 70 of each of planetary gears 60, causing makeup brushes 12 to rotate about their own longitudinal axes 72. According to the preferred operation of the present disclosure, brushes 12 revolve about longitudinal axis 68 of sun gear 58 multiple times. According to an alternative embodiment of the present disclosure, the direction of revolution of motor 30 may alternate from clockwise to counter-clockwise. According to an alternative embodiment of the present disclosure, other systems are provided that revolve brushes 12 about longitudinal axes 62 without rotating brushes 12 about their own longitudinal axes 66. According to another alternative embodiment of the present disclosure, other systems are provided that rotating brushes 12 about their own longitudinal axes without revolving brushes 12 about longitudinal axes.

During wash cycle 100, carriage 32 rotates and revolves plurality of makeup brushes 12 supported by carriage 32 against agitation pad 48, causing agitation against pad 48 and turbulence in the water and cleaning agent to aid in removing residual makeup from bristles 52 of brushes 12. Once wash cycle 100 is completed, water and cleaning agent are drained from housing 16 to drain tank 26.

During rinse cycle 104, water is preferably provided by water supply tank 24 to housing 16 and plurality of makeup brushes 12 supported by carriage 32. Carriage 32 rotates and revolves plurality of makeup brushes 12 supported by carriage 32, agitating bristles 52 against agitation pad 48 to aid in removing wash water from bristles 52 Additionally, turbulence in the rinse water aids in removing residual makeup and residual agent from bristles 52 and housing 16.

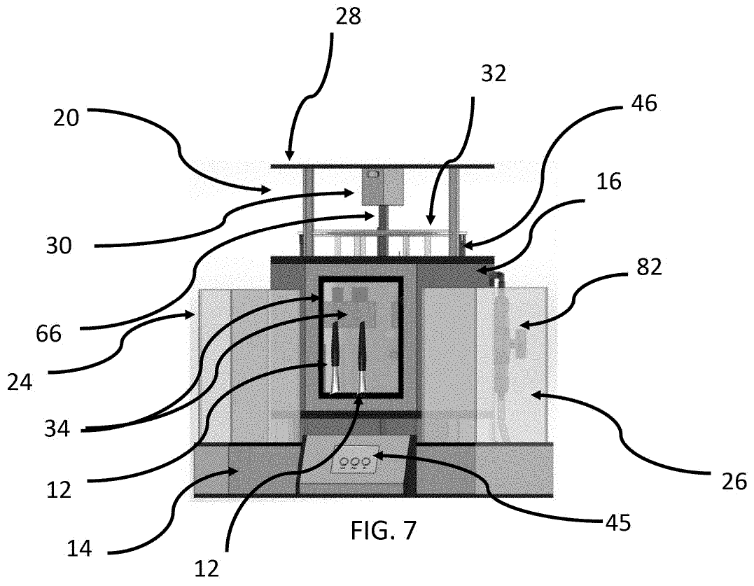

According to alternative embodiments, linear actuators 36 may move carriage 32 to a rinse position (see FIG. 7) so that bristles 52 of the plurality of brushes 12 supported by carriage 32 are not in contact with agitation pad 48 but are still submerged in water. Once rinse cycle 104 is completed, water is drained from housing 16 to drain tank 26.

According to the preferred embodiment, makeup brush cleaning device 10 includes water supply tank 24, which is filled with water by the user. However, according to alternative embodiments, the water supply may be a municipal or private water supply including a pipe or tube connected to device 10 to provide water to water supply tank 24 or directly to housing 16 without a water supply tank 24. Additionally, according to the preferred embodiment, water supply tank 24 of makeup brush cleaning device 10 includes at least one supply pump 74 and hoses 76 positioned to move liquids, such as water or cleaning agent, from water supply tank 24 to housing 16. Similarly, device 10 includes a drain pump 78 and hoses 80 positioned to move liquids from housing 16 to drain tank 26. Water supply tank 24 and housing 16 include outlets/inlets connected to hosing 76. Similarly, housing 16 and drain tank 26 include outlets/inlets connected to hosing 80. According to the preferred embodiment, device 10 includes a valve 82 positioned on hose 80 to control the flow of fluid to drain tank 26.

Before beginning a dry cycle 106, linear actuators 36 raise carriage 32 to a raised position inside housing 16, as shown in FIG. 7. When carriage 32 is in a raised position, bristles 52 of makeup brushes 12 are at a height that is substantially the same as an outlet 84A of a forced air source 84. Forced air source 84 preferably includes an intake fan 84B, a resisted heat source 84C, and outlet/nozzle 84A.

During dry cycle 106, air is provided to housing 16 and plurality of brushes 12 supported by carriage 32. Motor 30 and carriage 32 rotate and revolve plurality of brushes 12 supported by carriage 32 by nozzle 84A of forced air supply 84.

Once dry cycle 106 is completed, the user may remove plurality of makeup brushes 12 from carriage 32 by removing lid 20 from housing 16. The user may then remove plurality of makeup brushes 12 from clamps 40 and may insert additional makeup brushes into clamps 40 to wash, rinse, and/or dry the additional makeup brushes 12 as described herein.

According to the preferred embodiment, base 14 includes an electronics compartment 86. Electronics compartment 86 includes angled walls 86A which surround electronics (not shown) housed within electronics compartment 86. According to the preferred embodiment, angled walls 86A are positioned to create a baffle 86B positioned to direct excess or leaked fluids (not shown) to an irrigated channel 86C in base 14 and away from the electronics.

What is claimed is:

1. A makeup brush cleaning device assembly including
a makeup brush cleaning device including
a housing,
a carriage positioned in the housing,
a water supply, and
a forced air source, and
a plurality of makeup brushes supported by the carriage, the water supply being positioned to provide water to the plurality of makeup brushes during a wash cycle and a rinse cycle, the forced air source being positioned to provide air to the plurality of makeup brushes during a dry cycle.

2. The makeup brush cleaning device assembly of claim 1, wherein the forced air source includes a heat source that heats the air provided to the plurality of makeup brushes during the dry cycle.

3. The makeup brush cleaning device assembly of claim 1, wherein the makeup cleaning device includes an actuator positioned to move the carriage between a lowered position and a raised position.

4. The makeup brush cleaning device assembly of claim 1, wherein the carriage is configured to move the plurality of brushes by the forced air source during the dry cycle.

5. The makeup brush cleaning device assembly of claim 1, wherein the carriage includes a gear assembly coupled to the plurality of brushes to rotate the makeup brushes about longitudinal axes of the makeup brushes.

6. The makeup brush cleaning device assembly of claim 1, wherein the makeup brush cleaning device includes an abrasive surface positioned to contact bristles of the plurality of makeup brushes during the wash cycle.

7. The makeup brush cleaning device assembly of claim 1, wherein the water supply includes a tank that is filled by the user.

8. A makeup brush cleaning device including,
a housing,
a carriage positioned in the housing, the carriage including
a plurality of brush supports each configured to support at least one makeup brush, and
a gear assembly coupled to the plurality of brush supports and configured to rotate the makeup brushes about longitudinal axes of the makeup brushes.

9. The makeup brush cleaning device of claim 8, further including a water source positioned to provide water to the housing during a wash cycle with the gear assembly rotating the brush supports.

10. The makeup brush cleaning device of claim 8, further including a forced air source positioned to provide forced air to the housing during a dry cycle with the gear assembly rotating the brush supports.

11. The makeup brush cleaning device of claim 8, wherein the gear assembly is configured to revolve the plurality of makeup brushes about an axis while rotating the plurality of makeup brushes about the longitudinal axes of the makeup brushes.

12. The makeup brush cleaning device of claim 8, wherein the brush supports include clamps configured to grasp the plurality of makeup brushes and suspend the plurality of makeup brushes in the housing, the clamps having a shell including at least two outer jaws and hinge configured to move the at least two outer jaws between an open position and closed position, when in the open position the at least two outer jaws are configured to allow a user to insert a makeup brush in the clamps, the clamps having a malleable inner piece, when in the closed position, the outer jaws are a configured to grasp a handle of the makeup brush, when the at least one makeup brush is inserted, the malleable inner piece is configured to conform to a size and a shape of the handle of the makeup brush.

13. A makeup brush cleaning device assembly including,
a plurality of makeup brushes, and
a makeup brush cleaning device including
a housing
a carriage supported by the housing and supporting the plurality of makeup brushes, and
a motor coupled to carriage to revolve the plurality of makeup brushes about an axis.

14. The makeup brush cleaning device assembly of claim 13, wherein the makeup brush cleaning device further includes a water source positioned to provide water to the plurality of makeup brushes during a wash cycle.

15. The makeup brush cleaning device assembly of claim 13, wherein the makeup brush cleaning device further includes a forced air source positioned to provide forced air to the plurality of makeup brushes during a dry cycle.

16. The makeup brush cleaning device assembly of claim 13. wherein the carriage is configured to rotate the makeup brushes about longitudinal axes of the makeup brushes.

17. The makeup brush cleaning device assembly of claim 13, wherein the makeup cleaning device includes an actuator positioned to move the carriage between a raised position and a lowered position.

18. The makeup brush cleaning device assembly of claim 13, further including a removable lid including a lid housing and the motor positioned in the lid housing.

19. The makeup brush cleaning device assembly of claim 18, further including an electrical connection communicating electricity to the motor, the electrical connection has a first connector supported by the housing and a second connector supported by the lid, the first and second connectors are in contact to communicate electricity when the lid is supported by the housing and the first and second connectors are separated when the lid is removed from the housing.
